(19) United States
(12) Patent Application Publication
(10) Pub. No.: US 2014/0168530 A1
(43) Pub. Date: Jun. 19, 2014

(54) POLARIZATION STRUCTURE WITH TOUCH FUNCTION

(71) Applicant: Chih-Chung Lin, Taipei City (TW)

(72) Inventor: Chih-Chung Lin, Taipei City (TW)

(21) Appl. No.: 13/760,060

(22) Filed: Feb. 6, 2013

(30) Foreign Application Priority Data
Dec. 19, 2012 (TW) 101148204

(51) Int. Cl. G02F 1/1333; G06F 3/041

(52) U.S. Cl. CPC G02F 1/13338; G06F 3/041
USPC 349/12; 345/174

(57) ABSTRACT

The present invention provides a polarization structure with touch functions, including a first polarization plate, a transparent substrate having an inductive electrode layer, a first conductive glue layer, and a first adhesive layer, one side of the first conductive glue layer being attached to the inductive electrode layer and the other side thereof being attached to an FPC, the first adhesive layer being disposed between the first polarization plate and the transparent substrate, whereby the first polarization plate is attached to the transparent substrate. The structure of the present invention is applied to an LCD module and thus the manufacturing yield can be increased and the touch functions can be fulfilled.

This application claims the priority benefit of Taiwan patent application number 101148204 filed on Dec. 19, 2012.

### BACKGROUND OF THE INVENTION

1. Field of the Invention

The present invention relates to a polarization structure and in particular to a polarization structure with touch functions and high manufacturing yield.

2. Description of Prior Art

Recently, various flat display devices have been developed, such as the liquid crystal display (LCD), field emission display (FED), plasma display panel (PDP), and light emitting display (LED). Among the above flat display devices, the LCD device has been widely used due to advantageous features such as low power consumption, thin profile, and enhanced brightness.

The LCD device of the prior art provides only video images for observers and can not provide the touch functions for interaction with the observers; hence an embedded touch LCD device has been developed by the industry. During the assembling of the embedded touch LCD device, the touch sensing electrodes are integrated into the display panel such that the display panel itself has the touch function.

Though the embedded touch LCD device of the prior art has the touch function, another problem occurs. That is the manufacturing process of the display panel of the LCD device of the prior art is different from that of the embedded touch LCD device such that a simplified manufacturing process can not be achieved and because the touch sensing electrodes of the embedded touch LCD device are disposed in the display panel, it is really difficult to maintain or replace the touch sensing electrodes when damage or contact failure of the touch sensing electrode is detected. Accordingly, the glass substrate and touch sensing electrodes thereon in a new display panel have to be replaced and the manufacturing cost is increased.

Besides, during the manufacturing process of the display panel of the embedded touch LCD device, the x-axis and y-axis sensing electrodes of the touch sensing electrodes have to be bridged and need more manufacturing masks, resulting in increased manufacturing process steps.

The above prior art suffers the following disadvantages:

1. low manufacturing yield;
2. increased manufacturing cost; and
3. the production and assembling processes can not be simplified and the sensing electrodes can not be uninstalled, inspected, and maintained easily.

Therefore, how to overcome the above problems and disadvantages is the focus which the inventor and the related manufacturers in this industry have been devoting themselves to.

### SUMMARY OF THE INVENTION

Thus, to effectively overcome the above problems, the primary objective of the present invention is to provide a polarization structure with touch functions to fulfill the touch function.

Another objective of the present invention is to provide a polarization structure with touch functions which has an increased manufacturing yield and low manufacturing cost.

The yet another objective of the present invention is to provide a polarization structure with touch functions which can be produced and assembled easily, and replaced and maintained conveniently.

To achieve the above objectives, the present invention provides a polarization with touch functions including a first polarization plate, a transparent plate, a first conductive glue layer, and a first adhesive layer. The transparent plate has an inductive electrode layer which is selected to be disposed on either side of the transparent plate. One side of the first conductive glue layer is attached on the corresponding inductive electrode layer and the other side thereof is attached on one end of an FPC (Flexible Printed Circuit), and the FPC is made electrically connected to the inductive electrode layer through the first conductive glue layer. The first adhesive layer is disposed between the first polarization plate and the transparent substrate, whereby to attach the first polarization plate to the transparent substrate. By means of the design of the combination of the first polarization plate and the inductive electrode layer on the transparent plate, applied to an LCD module, the resultant LCD module can fulfill the touch functions. Also, the manufacturing yield can be effectively increased, the production and assembling processes can be simplified, and the LCD module can be conveniently uninstalled and replaced or maintained.

BRIEF DESCRIPTION OF DRAWING

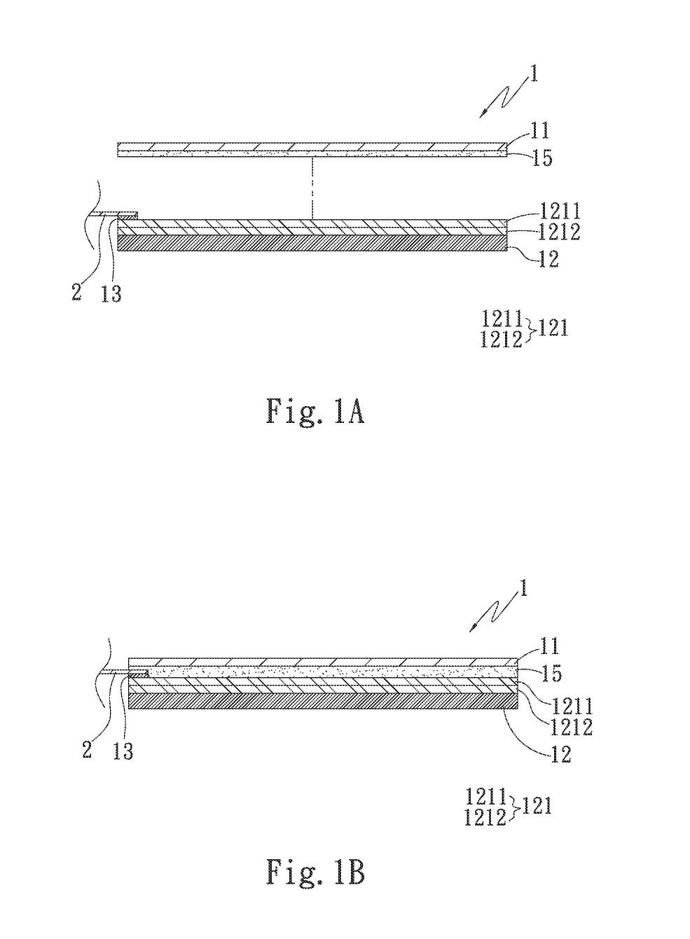

FIG. 1A is an exploded cross-sectional view of the polarization structure according to the first preferred embodiment of the present invention;

FIG. 1B is a combined cross-sectional view of the polarization structure according to the first preferred embodiment of the present invention;

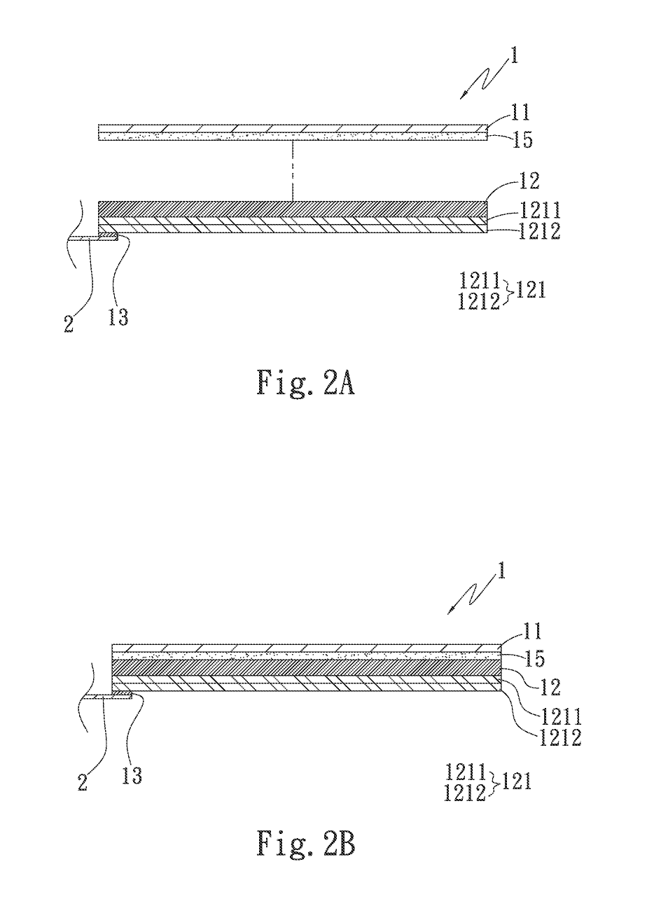

FIG. 2A is an exploded cross-sectional view of the polarization structure according to the second preferred embodiment of the present invention;

FIG. 2B is a combined cross-sectional view of the polarization structure according to the second preferred embodiment of the present invention;

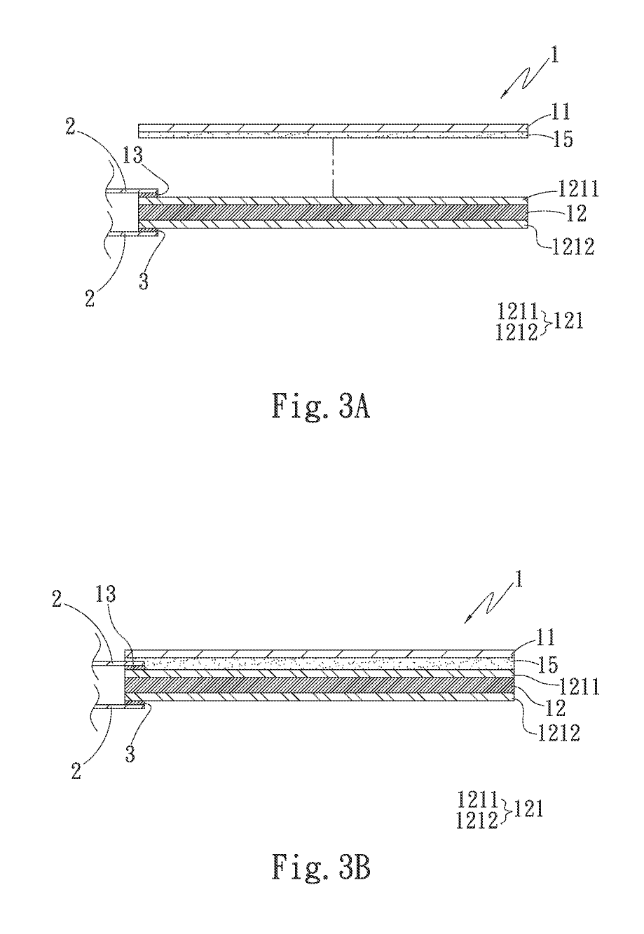

FIG. 3A is an exploded cross-sectional view of the polarization structure according to the third preferred embodiment of the present invention;

FIG. 3B is a combined cross-sectional view of the polarization structure according to the third preferred embodiment of the present invention;

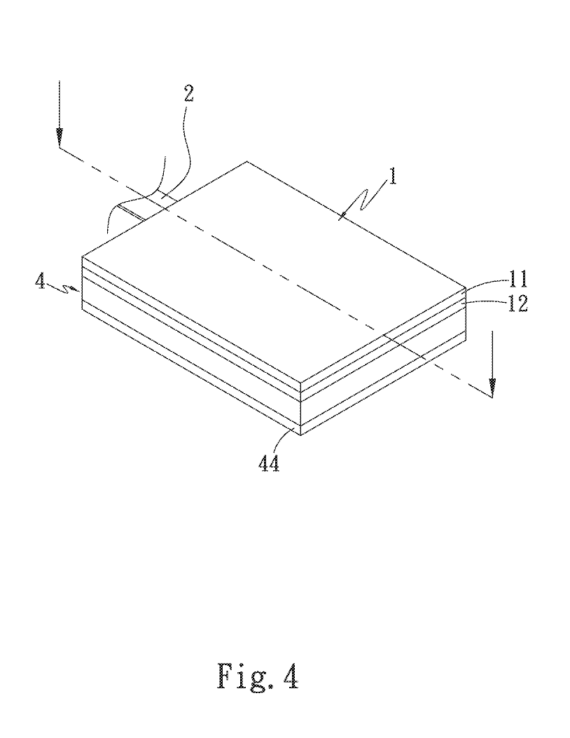

FIG. 4 is perspective view of the polarization structure of the present invention combined with an LCD module;

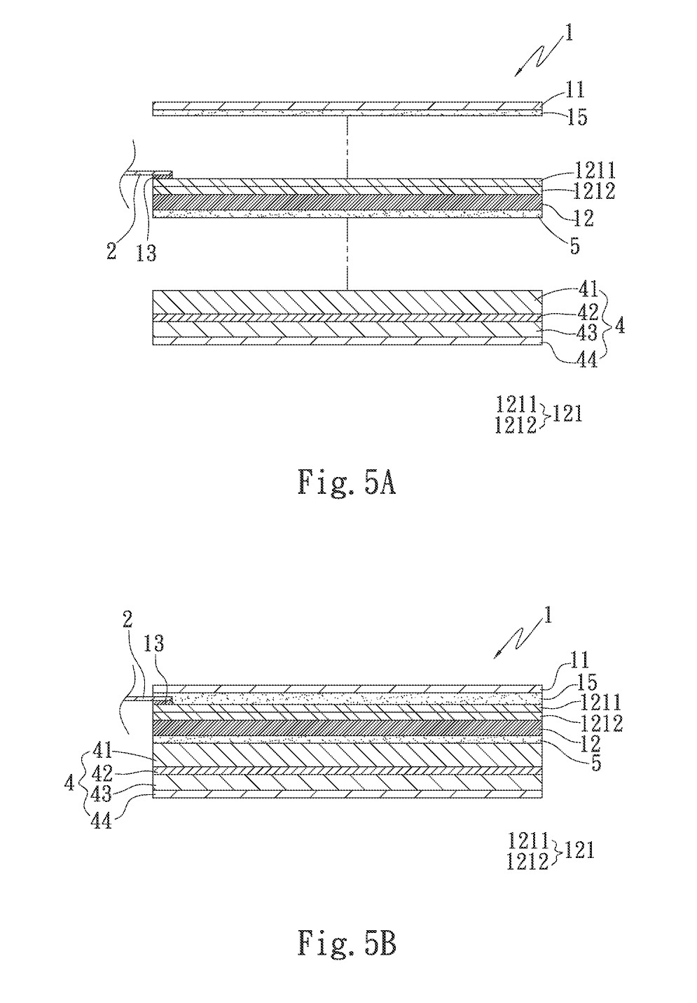

FIG. 5A is an exploded cross-sectional view of the polarization structure according to the fourth preferred embodiment of the present invention;

FIG. 5B is a combined cross-sectional view of the polarization structure according to the fourth preferred embodiment of the present invention;

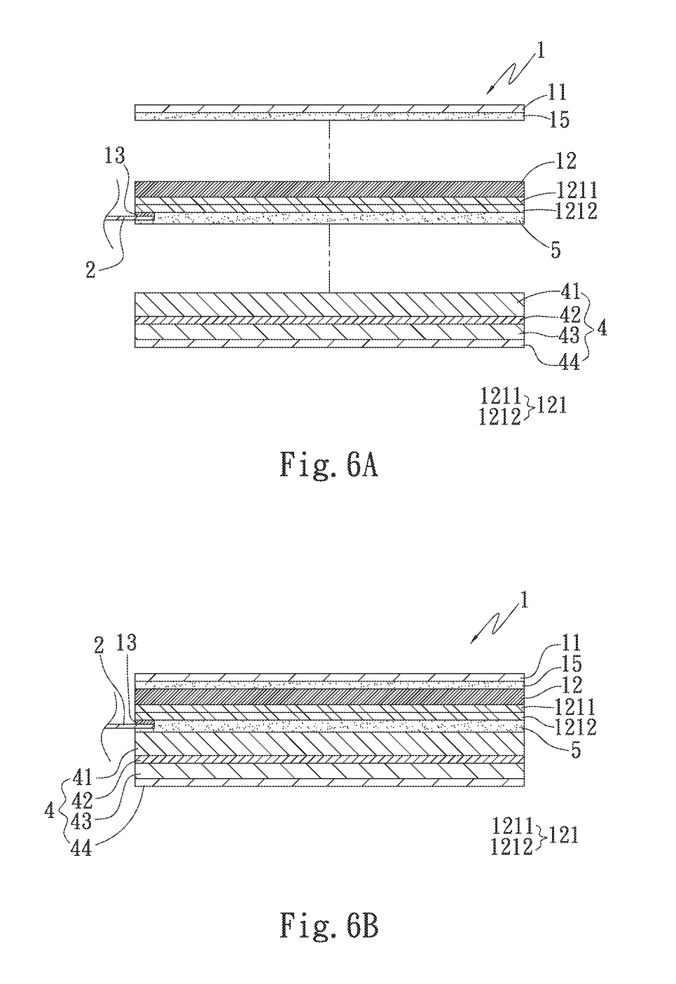

FIG. 6A is an exploded cross-sectional view of the polarization structure according to the fifth preferred embodiment of the present invention;

FIG. 6B is a combined cross-sectional view of the polarization structure according to the fifth preferred embodiment of the present invention;

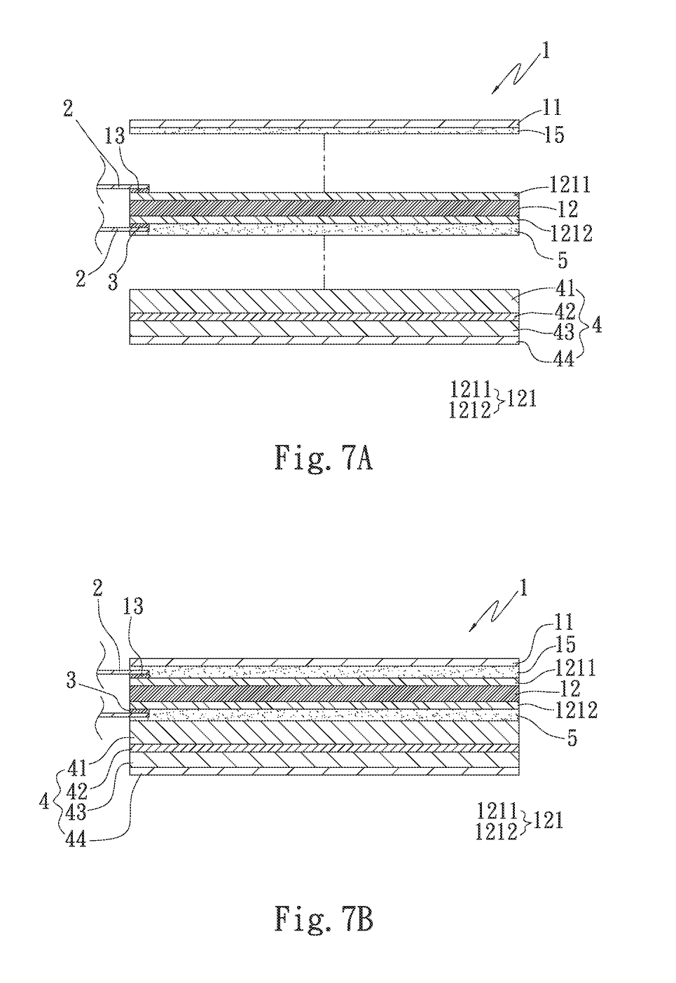

FIG. 7A is an exploded cross-sectional view of the polarization structure according to the sixth preferred embodiment of the present invention; and

FIG. 7B is a combined cross-sectional view of the polarization structure according to the sixth preferred embodiment of the present invention.

### DETAILED DESCRIPTION OF THE INVENTION

The above objectives of the present invention and the features of structure and function of the present invention are described according to preferred embodiments in figures.

The present invention provides a polarization structure with touch functions, referring to FIGS. 1A and 1B which are an exploded cross-sectional view and a combined cross-sectional view of the polarization structure according to the first embodiment of the present invention, respectively. The polarization structure 1 includes a first polarization plate 11, a transparent substrate 12, a first conductive glue layer 13, and a first adhesive layer 15. The first adhesive layer 15 is optical clear adhesive (OCA), optical clear resin (OCR), or liquid adhesive lamination (LAL). The first adhesive layer 15 is disposed between the first polarization plate 11 and the transparent substrate 12, whereby to attach the first polarization plate 11 to the transparent substrate 12.

Also, the side of the first polarization plate 11 opposite to the transparent substrate 12 is for the user to perform the touch using a finger or a stylus. The material of the transparent substrate 12 is, but not limited to, Polyethylene Terephthalate (PET) for explanation in the preferred embodiment. In practice, the material of the transparent substrate 12 can be selected from the group consisting of poly carbonate (PC), polyethylene (PE), Poly Vinyl Chloride (PVC), Poly Propylene (PP), Poly Styrene (PS), Polymethylmethacrylate (PMMA), cyclo olefin copolymer (COC), and glass.

Moreover, the transparent substrate 12 has an inductive electrode layer 121, the inductive electrode layer 121 being selected to be disposed on either side of the transparent substrate 12. In the preferred embodiment, the inductive electrode layer 121 is disposed on one side of the transparent substrate 12 for explanation. The inductive electrode layer 121 includes a plurality of first inductive electrodes 1211 and a plurality of second inductive electrodes 1212 which are either indium tin oxide (ITO) films or antimony tin oxide (ATO) films.

In the preferred embodiment, the first and second inductive electrodes 1211, 1212 are interlaced each other, electrically insulated each other, and formed on one side of the transparent substrate 12, but not limited to this. In practice, the designer can change the corresponding arrangement and patterns of the first and second inductive electrodes 1211, 1212 according to the requirements of touch-sensing sensitivity and layout space; for example, the first and second inductive electrodes 1211, 1212 are formed correspondingly on one side of the transparent substrate 12.

Besides, the first and second inductive electrodes 1211, 1212 in the preferred embodiment are formed on one side of the transparent substrate 12 by sputtering, but not limited to this. Sol-gel coating, electroplating, or evaporation also can be used.

Please continuously refer to FIGS. 1A and 1B. In the preferred embodiment, the first conductive glue layer 13 uses anisotropic conductive film (ACF), as an example for explanation, but not limited to this. One side of the first conductive glue layer 13 is attached on the corresponding side of the inductive electrode layer 121 and the other side thereof is attached on one end of the FPC 2, whereby the FPC 2 is electrically connected to the inductive electrode layer 121 through the first conductive glue layer 13. The inductive electrode layer 121 and one end of the FPC 2 thereon are glued to the corresponding first polarization plate 11 through the first adhesive layer 15.

Therefore, by means of the design of the combination of the first polarization plate 11 and the inductive electrode layer 121 on the transparent substrate 12, the polarization structure 1 can fulfill the touch functions and can be conveniently replaced and maintained.

Please refer to FIGS. 2A and 2B which are an exploded cross-sectional view and a combined cross-sectional view of the polarization structure according to the second preferred embodiment of the present invention, respectively. The structure, the relation of components, and the effects of the current preferred embodiment are similar to those of the first embodiment, thus not described again here. In the current preferred embodiment, the first and second inductive electrodes 1211, 1212 in the first embodiment are now designed on the other side of the transparent substrate 12. That is, the first and second inductive electrodes 1211, 1212 are interlaced each other, electrically insulated each other, and formed on the other side of the transparent substrate 12.

Besides, one side of the above transparent substrate 12 is glued to the corresponding first polarization plate 11 through the first adhesive layer 15.

Please refer to FIGS. 3A and 3B which are an exploded cross-sectional view and a combined cross-sectional view of the polarization structure according to the third preferred embodiment of the present invention, respectively. The structure, the relation of components, and the effects of the current preferred embodiment are similar to those of the first preferred embodiment, thus not described again here. In the current preferred embodiment, the first and second inductive electrodes 1211, 1212 in the first preferred embodiment are now designed on the respective side of the transparent substrate 12. That is, the first inductive electrodes 1211 are disposed on one side of the transparent substrate 12; the first inductive electrodes 1211 and one end of the FPC 2 thereon are glued to the corresponding first polarization plate 11 through the first adhesive layer 15.

Besides, the second inductive electrodes 1212 and a second conductive glue layer 3 are disposed on the other side of the transparent substrate; in the current preferred embodiment, the second conductive glue layer 3 and the first conductive glue layer 13 use ACF, as an example for explanation. The other end of the FPC 2 is electrically connected to the second inductive electrodes 1212 through the second conductive glue layer 3.

Please refer to FIGS. 5A and 5B which are an exploded cross-sectional view and a combined cross-sectional view of the polarization structure according to the fourth preferred embodiment of the present invention, respectively, as well as FIG. 4. In the current preferred embodiment, the polarization structure 1 of the first preferred embodiment is applied to an LCD module 4. That is, the other side of the transparent substrate 12 of the above polarization structure 1 is attached on an LCD module 4 having a first substrate 41, a liquid crystal layer 42, a second substrate 43, and a second polarization plate 44, wherein the liquid crystal layer 42 is disposed between the first and second substrates 41, 43, and the second polarization plate 44 is attached on the side of the second substrate 43 opposite to the liquid crystal layer 42; also, a backlight module (not shown) which provides a light source for the LCD module 4 is attached underneath the second polarization plate 44, in which the above first and second substrates 41, 43 are glass substrates, as an example for explanation.

Moreover, a second adhesive layer 5 is disposed between the transparent substrate 12 and the corresponding LCD module 4. The second adhesive layer 5 and the first adhesive layer 15 are OCA, OCR, or LAL. The other side of the transparent substrate 12 is attached to the first substrate 41 of the LCD module 4 through the second adhesive layer 5 to form a touch display module 4 (that is, the so-called touch display device).

Consequently, the polarization structure 1 of the present invention is suitable for the LCD module 4 without touch functions. Only the upper polarization plate of the original LCD module 4 is directly replaced with the polarization structure 1 of the present invention and the resultant LCD module 4 can achieve the touch functions. In addition, compared with the embedded touch LCD device technology of the prior art, the present invention can simplify the production and assembling processes. For example, the number of manufacturing masks is reduced. As a result, the manufacturing yield is increased, and then the manufacturing cost is reduced.

Besides, since the inductive electrode layer 121 of the present invention is disposed on one side of the transparent substrate 12, when inspection is conducted during the manufacturing process, and damage or contact failure of the inductive electrode layer 121 is detected, only a new modularized polarization structure 1 is substituted or the damaged inductive electrode layer 121 is uninstalled to repair. It is not necessary to replace the substrate (that is, the glass substrate) of the new LCD module and thus the effects of convenient disassembling, replacement, and maintenance can be achieved.

Please refer to FIGS. 6A and 6B which are an exploded cross-sectional view and a combined cross-sectional view of the polarization structure according to the fifth preferred embodiment of the present invention, respectively, as well as FIG. 4. In the current preferred embodiment, the polarization structure 1 of the second preferred embodiment is applied to a LCD module 4. That is, the inductive electrode layer 121 of the transparent substrate 12 of the above polarization structure 1 is attached on the LCD module 4 having a first substrate 41, a liquid crystal layer 42, a second substrate 43, and a second polarization plate 44, wherein the liquid crystal layer 42 is disposed between the first and second substrates 41, 43, and the second polarization plate 44 is attached on the side of the second substrate 43 opposite to the liquid crystal layer 42; also, a backlight module (not shown) which provides a light source for the LCD module 4 is attached underneath the second polarization plate 44, in which the above first and second substrates 41, 43 are glass substrates, as an example for explanation.

Besides, a second adhesive layer 5 is disposed between the inductive electrode layer 121 of the above transparent substrate 12 and the corresponding LCD module 4. The second adhesive layer 5 and the first adhesive layer 15 are OCA, OCR, or LAL. The inductive electrode layer 121 and one end of the FPC 2 thereon are attached to the first substrate 41 of the LCD module 4 through the second adhesive layer 5 to form the LCD module 4 with touch functions (that is, the so-called touch display device).

Consequently, the polarization structure 1 of the present invention is suitable for the LCD module 4 without touch functions. Only the upper polarization plate of the original LCD module 4 is directly replaced with the polarization structure 1 of the present invention and the resultant LCD module 4 can achieve the touch functions. In addition, compared with the embedded touch LCD device technology of the prior art, the present invention can simplify the production and assembling processes. For example, the number of manufacturing masks is reduced. As a result, the manufacturing yield is increased, and then the manufacturing cost is reduced.

Also, since the inductive electrode layer 121 of the present invention is disposed on the other side of the transparent substrate 12, when inspection is conducted during the manufacturing process, and damage or contact failure of the inductive electrode layer 121 is detected, only a new modularized polarization structure 1 is substituted or the damaged inductive electrode layer 121 is uninstalled to repair. It is not necessary to replace the substrate (that is, the glass substrate) of the new LCD module and thus the effects of convenient disassembling, replacement, and maintenance can be achieved.

Please refer to FIGS. 7A and 7B which are an exploded cross-sectional view and a combined cross-sectional view of the polarization structure according to the sixth preferred embodiment of the present invention, respectively, as well as FIG. 4. In the current preferred embodiment, the polarization structure 1 of the third preferred embodiment is applied to a LCD module 4. That is, the second inductive electrodes 1212 of the transparent substrate 12 of the above polarization structure 1 are attached on the corresponding LCD module 4 having a first substrate 41, a liquid crystal layer 42, a second substrate 43, and a second polarization plate 44, wherein the liquid crystal layer 42 is disposed between the first and second substrates 41, 43, and the second polarization plate 44 is attached on the side of the second substrate 43 opposite to the liquid crystal layer 42; also, a backlight module (not shown) which provides a light source for the LCD module 4 is attached underneath the second polarization plate 44, in which the above first and second substrates 41, 43 are glass substrates, as an example for explanation.

Besides, a second adhesive layer 5 is disposed between the second inductive electrodes 1212 and the corresponding LCD module 4. The second adhesive layer 5 and the first adhesive layer 15 are OCA, OCR, or LAL. The second inductive electrodes 1212 and the other end of the FPC 2 thereon are attached to the first substrate 41 of the LCD module 4 through the second adhesive layer 5 to form the LCD module 4 with touch functions (that is, the so-called touch display device).

Consequently, the polarization structure 1 of the present invention is suitable for the LCD module 4 without touch functions. Only the upper polarization plate of the original LCD module 4 is directly replaced with the polarization structure 1 of the present invention and the resultant LCD module 4 can achieve the touch functions. In addition, compared with the embedded touch LCD device technology of the prior art, the present invention can simplify the production and assembling processes. For example, the number of manufacturing masks is reduced. As a result, the manufacturing yield is increased, and then the manufacturing cost is reduced.

Also, since the first and second inductive electrodes 1211, 1212 of the present invention are disposed on the respective side of the transparent substrate 12, when inspection is conducted during the manufacturing process, and damage or contact failure of the inductive electrode layer 121 is detected, only a new modularized polarization structure 1 is substituted or the damaged inductive electrode layer 121 is uninstalled to repair. It is not necessary to replace the substrate (that is, the glass substrate) of the new LCD module and thus the effects of convenient disassembling, replacement, and maintenance can be achieved.

In summary, the advantages of the present invention over those of the prior art are as follows:
1. The polarization structure of the present invention can be applied to the LCD module without touch functions and the resultant LCD module can achieve the touch functions;
2. The production and assembling processes are simplified and the manufacturing yield is increased; and
3. The manufacturing cost is reduced.

The above description is only about the preferred and feasible embodiments of the present invention. It will be understood that all variations of the above methods, shapes, structures, and apparatus according to the present invention should be embraced by the scope of the appended claims of the present invention.

What is claimed is:

1. A polarization structure with touch functions, including:
a first polarization plate;
a transparent substrate having an inductive electrode layer which is selected to be disposed on either side of the transparent substrate;
a first conductive glue layer, one side thereof being attached on the corresponding side of the inductive electrode layer and the other side thereof being attached on one end of an FPC, whereby the FPC is electrically connected to the inductive electrode layer through the first conductive glue layer; and
a first adhesive layer disposed between the first polarization plate and the corresponding transparent substrate, whereby to attach the first polarization plate to the transparent substrate.

2. The polarization structure with touch functions according to claim 1, wherein the inductive electrode layer includes a plurality of first inductive electrodes and a plurality of second inductive electrodes which are interlaced each other and electrically insulated each other, and formed on one side of the transparent substrate, wherein the inductive electrode layer and one end of the FPC thereon are glued to the corresponding first polarization plate through the first adhesive layer.

3. The polarization structure with touch functions according to claim 1, wherein the inductive electrode layer includes a plurality of first inductive electrodes and a plurality of second inductive electrodes which are interlaced each other and electrically insulated each other and formed on the other side of the transparent substrate.

4. The polarization structure with touch functions according to claim 1, wherein the inductive electrode layer includes a plurality of first inductive electrodes and a plurality of second inductive electrodes, wherein the first inductive electrodes are disposed on one side of the transparent substrate, wherein the first inductive electrodes and one end of the FPC thereon are glued to the corresponding first polarization plate through the first adhesive layer, wherein the second inductive electrodes and a second conductive glue layer are disposed on the other side of the transparent substrate, wherein the other end of the FPC is electrically connected to the second inductive electrodes through the second conductive glue layer.

5. The polarization structure with touch functions according to claim 2, wherein the other side of the transparent substrate is attached on an LCD module having a first substrate, a liquid crystal layer, a second substrate, and a second polarization plate, wherein the liquid crystal layer is disposed between the first and second substrates, and the second polarization plate is attached on the side of the second substrate opposite to the liquid crystal layer.

6. The polarization structure with touch functions according to claim 5, wherein a second adhesive layer is disposed between the transparent substrate and the corresponding LCD module, wherein the transparent substrate is attached to the LCD module through the second adhesive layer to form a touch display device.

7. The polarization structure with touch functions according to claim 3, wherein the inductive electrode layer of the transparent substrate is attached on an LCD module having a first substrate, a liquid crystal layer, a second substrate, and a second polarization plate, wherein the liquid crystal layer is disposed between the first and second substrates, and the second polarization plate is attached on the side of the second substrate opposite to the liquid crystal layer.

8. The polarization structure with touch functions according to claim 7, wherein a second adhesive layer is disposed between the inductive electrode layer and the corresponding LCD module, wherein the inductive electrode layer and one end of the FPC thereon are attached to the LCD module through the second adhesive layer to form a touch display device.

9. The polarization structure with touch functions according to claim 4, wherein the second inductive electrodes of the transparent substrate are attached on an LCD module having a first substrate, a liquid crystal layer, a second substrate, and a second polarization plate, wherein the liquid crystal layer is disposed between the first and second substrates, and the second polarization plate is attached on the side of the second substrate opposite to the liquid crystal layer.

10. The polarization structure with touch functions according to claim 9, wherein a second adhesive layer is disposed between the second inductive electrodes and the LCD module, wherein the second inductive electrodes and the other end of the FPC are attached to the LCD module to form a touch display device.

11. The polarization structure with touch functions according to claim 2, wherein the first and second inductive electrodes are either indium tin oxide films or antimony tin oxide films.

12. The polarization structure with touch functions according to claim 3, wherein the first and second inductive electrodes are either indium tin oxide films or antimony tin oxide films.

13. The polarization structure with touch functions according to claim 4, wherein the first and second inductive electrodes are either indium tin oxide films or antimony tin oxide films.

14. The polarization structure with touch functions according to claim 6, wherein the first and second adhesive layers are either optical clear adhesive or optical clear resin.

15. The polarization structure with touch functions according to claim 8, wherein the first and second adhesive layers are either optical clear adhesive or optical clear resin.

16. The polarization structure with touch functions according to claim 10, wherein the first and second adhesive layers are either optical clear adhesive or optical clear resin.

17. The polarization structure with touch functions according to claim 1, wherein the material of the transparent substrate is selected from the group consisting of polyethylene terephthalate, poly carbonate, polyethylene, poly vinyl chloride, ploy propylene, poly styrene, polymethylethacrylate, cyclo olefin copolymer, and glass.
